(19) United States
(12) Patent Application Publication
(10) Pub. No.: US 2013/0190121 A1
(43) Pub. Date: Jul. 25, 2013

(54) ROLLER CHAIN WELDED EXTENDED PIN

(71) Applicants: Vernon Eugene Skipper, Cordova, IL (US); James David McLuckie, Savanna, IL (US); Donald John Noordt, Clinton, IA (US); Garrett James Griffy, Fulton, IL (US); Thomas Christopher Paul, Clinton, IA (US)

(72) Inventors: Vernon Eugene Skipper, Cordova, IL (US); James David McLuckie, Savanna, IL (US); Donald John Noordt, Clinton, IA (US); Garrett James Griffy, Fulton, IL (US); Thomas Christopher Paul, Clinton, IA (US)

(73) Assignee: The Timken Company, Canton, OH (US)

(21) Appl. No.: 13/734,611

(22) Filed: Jan. 4, 2013

Related U.S. Application Data
(60) Provisional application No. 61/583,480, filed on Jan. 5, 2012.

(51) Int. Cl. F16G 13/06

(52) U.S. Cl. CPC F16G 13/06
USPC 474/206; 59/4

(57) ABSTRACT

A roller chain may include a link having a pair of outer plates connected to a pair of pins, where one of the pins sufficiently extends outside the plate to facilitate connection with a stud and thereby provide connection for attachments.

### RELATED APPLICATIONS

This application is based on and claims priority to provisional U.S. Patent Application No. 61/583,480, filed Jan. 5, 2012, the contents of which are herein incorporated by reference.

### FIELD OF THE DISCLOSURE

The present disclosure is related to a stud connected to an extended pin on a link of a roller chain, a method of manufacturing an extended pin/stud combination on the link and a chain including the extended pin and stud, and more particularly, to a multi-component extended pin and stud coupled to a sidebar in a link of a roller chain, a method of manufacturing the link with the extended pin and stud and a chain including the link with the extended pin and stud.

### BACKGROUND

Roller chain is a type of chain drive designed for the transfer of mechanical power in many kinds of domestic, industrial and agricultural machinery, including conveyors, wire and tube drawing machines, printing presses, cars, motorcycles, and simple machines like bicycles. The chain is commonly driven by a toothed wheel called a sprocket. Commonly, a roller chain has a series of links designed to mesh with the teeth of the sprockets of the machine, and are flexible in only one dimension. Each link may include short cylindrical rollers held together by side links by an axle that is connected to the side links and passes through the rollers. It is a simple, reliable, and efficient means of power transmission.

Generally, as shown in FIGS. 1 and 2, there are two types of links sequentially alternating in the roller chain A. The first type is an inner link B that has two parallel inner plates C held together by two axles or bushings D, press or interference fit to the inner plates, upon and about which two rollers F may rotate. Inner links A alternate with the second type, the outer links F, consisting of two outer plates G held together by pins H, press or interference fit to the outer plates, that pass through the bushings D of the inner links A. The roller chain design reduces friction compared to simpler designs, resulting in higher efficiency and less wear. The original power transmission chain varieties lacked rollers and bushings, with both the inner and outer plates held by pins which directly contacted the sprocket teeth; however this configuration exhibited extremely rapid wear of both the sprocket teeth, and the plates where they pivoted on the pins. This problem was partially solved by the development of bushed chains, with the pins holding the outer plates passing through bushings or sleeves connecting the inner plates. This distributed the wear over a greater area; however the teeth of the sprockets still wore more rapidly than is desirable, from the sliding friction against the bushings. The addition of rollers surrounding the bushing sleeves of the chain and provided rolling contact with the teeth of the sprockets resulting in excellent resistance to wear of both sprockets and chain as well. There is even very low friction, as long as the chain is sufficiently lubricated. Continuous, clean, lubrication of roller chains is of primary importance for efficient operation as well as correct tensioning. Carbon steel is a standard material of construction, but where corrosion protection or corrosion resistance are required, there are options of nickel plating, N.E.P. (carbon steel chain with a special multi layer protective coating), stainless steel and engineering plastic combinations. Lube-free chain is available for long term operation without the need for additional lubrication, particularly for sensitive industries such as food, beverage and pharmaceuticals.

Attachments to the roller chain offer a whole range of possibilities for a chain designer or user. Virtually any chain can include attachment links, which allow users to fasten screws to the chain or accurately position products. The possibilities are limited only by the imagination of the designer or user. While there are numerous standard attachments available to fit roller chain, more specialized, function related attachments are often needed in order to provide conveying solutions for OEM manufacturers or final consumers.

Common attachments may include an integrally formed or multi-piece constructed link sidebar that has an extended portion either in plane with the sidebar or normal to the plane of the sidebar or a link pin that extends well beyond the side bar. One conventional extended pin is a one-piece design that is connected to the link sidebar at one end. The remaining three pin ends are connected to the link side bars in a conventional manner. Some chain manufacturers recommend that the extended pin have no shoulder because the shoulder can compromise quality due to high stress concentrations at the point where diameters change. Such manufacturers believe that additions of sleeves or bearings on the extended pins will often yield a more dependable design. Another conventional one-piece extended pin design has a shoulder and an enlarged end. Generally, there are two steps in the pin diameter that allow the pin to be inserted into the side bar. The first step is a shoulder that is press or interference fit into a non-standard opening in one of the outer link side bars and connected to the other outer link side bar in a conventional manner. The second step is the portion of the roller chain pin that fits inside the roller chain bushing or axle. However, this design does have some disadvantages, namely, there are high stress concentrations, if the second stepped portion needs to be plated, then the pin must be masked at the time of plating and may need to be plunge ground after plating, the cost is often high due to the amount of scrap involved in making the one-piece pin design, the sidebar must have at least one hole specifically sized to accept the shoulder on the extended pin, and the extended pin can turn inside the sidebar when high loads are applied.

Therefore, there is a need in the art for an extended pin design that overcomes the aforementioned disadvantages and provides lower costs.

### BRIEF DESCRIPTION OF THE DRAWINGS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

FIG. 1 is a cross-section view of a conventional bush roller chain.

FIG. 2 is an exploded view of a conventional bush roller chain.

FIG. 3 is a top plan view of an outer link having an extended pin in accordance with one embodiment of the present disclosure with inner links removed for clarity.

FIG. 4 is a top plan view of a stud or cap pin in accordance with one embodiment of the present disclosure.

FIG. 5 is a side elevation view of the cap pin of FIG. 4.

FIG. 6 is an end elevation view of the cap pin of FIG. 4.

FIG. 7 is a top plan view of a chain formed of a series of outer and inner links and a combination of the extended pin of FIG. 3 and the stud of FIGS. 4-6 with a method of manufacturing.

### DETAILED DESCRIPTION

The present disclosure is not limited to the particular details of the apparatus depicted, and other modifications and applications may be contemplated. Further changes may be made in the apparatus, device or methods without departing from the true spirit of the scope of the disclosure herein involved. It is intended, therefore, that the subject matter in this disclosure should be interpreted as illustrative, not in a limiting sense.

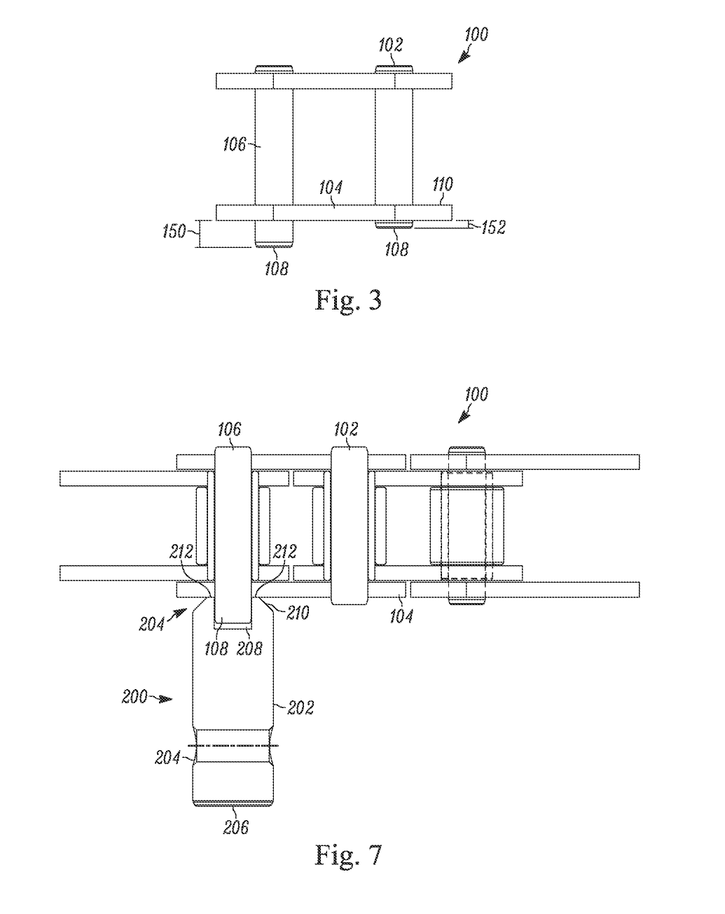

FIG. 3 illustrates a top plan view of an outer link assembly 100 in accordance with one embodiment of the present disclosure. The outer link 100 may include a standard pin 102 and extended pin 106 that are each pressed into a standard sidebar 104 (i.e., having a pair of standard conventional openings) in what may be described as an interference fit or other suitable connection, such as, a press fit, friction fit, shrink fit, location fit, transition fit, engineering fit, force fit, precision fit (which shall all be commonly referred to as “interference fit” herein), as necessary to obtain or achieve the desired result as described herein. The standard pin 102 and the extended pin 106 may each have a continuous standard diameter and a portion 108 that projects from an exterior side 110 of the sidebar 104. This portion 108 of the standard pin 102 is useful to additionally secure the connection of the pin 102 to the sidebar 104 in a known manner, such as, for example only, staking, riveting, spinning or any other suitable manner. The portion 108 of the extended pin 106, however, is not useful to secure the connection to the sidebar 104 and projects a distance 150 further from the exterior side 110 than a distance 152 the portion 108 of the standard pin 102. Preferably, in one embodiment the distance 150 may be 0.045 inches. The distance may have other dimensional configurations such that a suitable connection between portion 108 and stud 200 can be made such as, but not limited to, distances greater than 0.01 inches. The standard and extended pins 102, 106 may be plated, painted, other otherwise coated, treated, etc. in order to provide the desired functionality. In one embodiment, the pins 102, 106 maybe chrome or nickel plated to resist wear and provide increased durability.

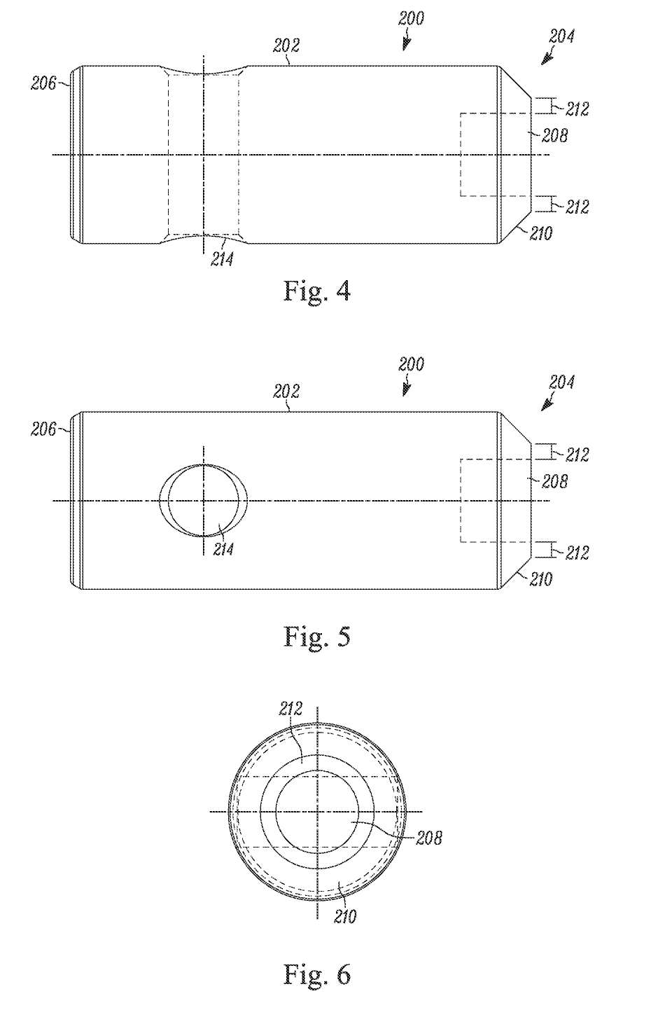

FIGS. 4, 5 and 6 respectively illustrate top, side and end views of a stud or cap pin 200 in accordance with one embodiment of the present disclosure. The stud 200 may include a main body 202, a connection end 204, and a free end 206. Preferably, in one embodiment, the connection and free ends 204, 206 are parallel or non-parallel, as desired. The main body 202 preferably has a diameter that is greater than a diameter of the extended pin 106 to provide the functionality as described herein. Preferably, in one embodiment, the main body 202 diameter is greater than 1.1 times the diameter of the extended pin 106. More preferably, the diameter of the main body 202 is greater than 1.5 times the diameter of the extended pin 106. Most preferably the diameter of the main body 202 is greater than 2.0 times the diameter of the extended pin 106. The connection end 204 may include a cavity 208, a chamfer 210 and a shoulder 212. The cavity 208 may be configured complementary to the portion 108 of the extended pin 106 such that the cavity 208 engages such portion 108 with an interference fit preferably or any other suitable connection manner. The chamfer 210 is disposed and extends from an exterior surface of the main body 202 to a point adjacent to but offset from a rim of the cavity 208 in order to define the shoulder 212 as an annulus disposed about the cavity 208. Preferably, in one embodiment the shoulder or annulus 212 may be 0.143 inches. In other embodiments, annulus 212 may be 0.04 to 0.2 inches but other configurations can also be used depending on various factors such as, but not limited to, the overall size of the chain and the size of stud 200. The stud 200 may also include in one or more embodiments, a feature, such as a bore 214 through the main body 202, to facilitate connection with other components or attachments. The stud 200 may be may be plated, painted, other otherwise coated, treated, etc. in order to provide the desired functionality or left in raw finished form, as may be provided in one embodiment. As a result, the stud 200 may be manufactured with less scrap than the prior one-piece design and provide increased flexibility of design over prior attempts.

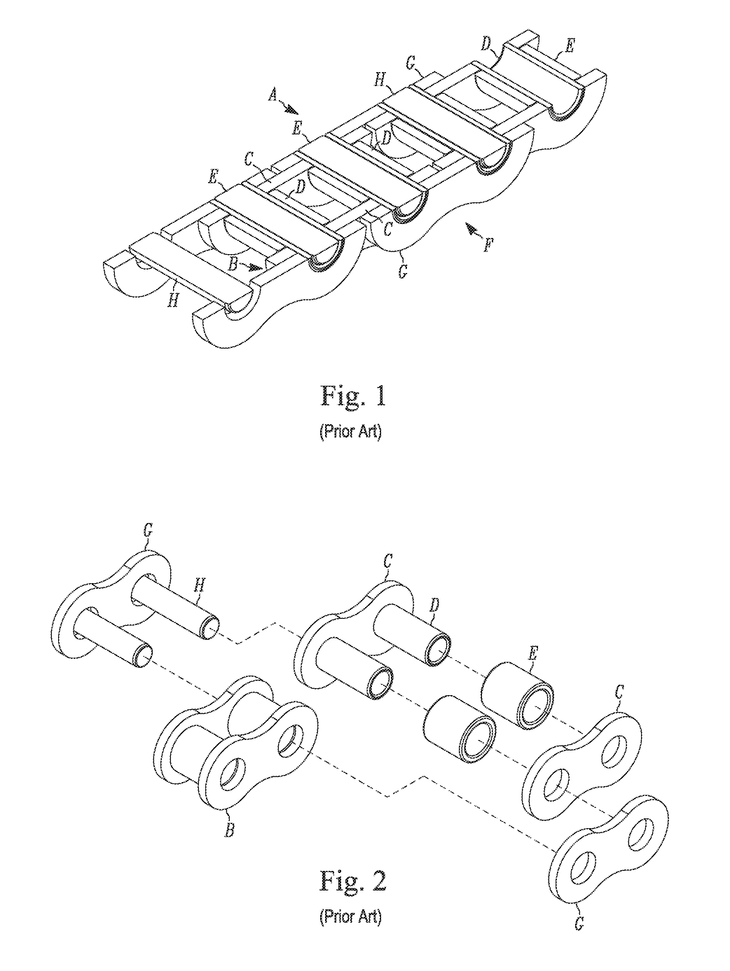

FIG. 7 illustrates a top plan view of a chain 300 formed of a series of outer 100 and inner 312 links and a combination of the extended pin 106 of FIG. 3 and the stud 200 of FIGS. 4-6 with a method of manufacturing. The chain 300 is constructed in a conventional manner as described herein with respect to FIGS. 1 and 2, except the extended pin 106 is used in place of another standard pin for at least one of the outer links 100. The inner links 302 are constructed in the conventional manner as described with respect to FIGS. 1 and 2. Then, the stud 200 is fitted to the portion 108 of the extended pin 106 after longitudinal alignment and registration, so that the stud 200 may engage such portion 108 as described herein. The stud 200 is preferably secured to the sidebar 104, and the extended pin 106 is preferably secured to the sidebar 104 and the stud 200 by a single upset welding process or other suitable process or manner to achieve the desired result such that all three of the parts are fused together to prevent the pin 106 from turning inside the sidebar 104 and to maintain connection of the stud 200 to the pin 106. Upset welding is a resistance welding process, in either a single-pulse or continuous mode, that utilizes both heat and deformation to form a weld. The heat is produced by resistance to the flow of electrical current at the interface of the abutting surfaces to be joined (i.e., the shoulder annulus 212 and sidebar 104, the cavity 208 and portion 108 of the extended pin 106, the extended pin 106 and the sidebar 104). The deformation results from force on the joint in combination with softening from the electrical resistance heat. Upset welding typically results in solid-state welds (no melting at the joint, which is not advantageous). The deformation at the weld joint provides intimate contact between clean adjoining surfaces, allowing formation of strong metallurgical bonds. If any melting does occur during upset welding, the molten metal is typically extruded out of the weld joint area, which is not desired in this disclosure, but is not detrimental as long as tolerances are maintained. Generally, wire, bar, strip, and tubing can be joined end to end with a single pulse of welding current. Whereas, seams on pipe or tubing can be joined using continuous upset welding by feeding a coiled strip into a set of forming rolls, resistance heating the edges with wheel electrodes, and applying a force to upset the edges together. A data acquisition system may be used to record the force, current, voltage, and motion of the weld head during welding. Equivalent welds may be made using both alternating and direct current. Upset welds have similar characteristics to inertia friction welds, which are also solid-state welds. The amount of deformation is usually less for upset welds, and the deformation can be more precisely controlled using upset welding. One benefit is that if the pin 106 must be plated, the cost is minimal because masking or subsequent plunge grinding is not necessary.

Preferably, the outer link 100 may be formed partially with a single standard pin 102, the extended pin 106 and a single standard side bar 104, such that connection of the pin 106, side bar 104 and stud 200 may be more easily accomplished and then incorporated into a roller chain 300 as would be understood by one of ordinary skill in the art for combination with another side bar 104 to complete the assembly of an outer link for the roller chain 300.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. An outer link of a roller chain comprising:
an outer plate including a pair of equally configured openings defined therein;
a first pin having a first continuous diameter, the first pin connected to one of the openings such that a first minor portion extends from an exterior side of the outer plate;
a second pin having a second continuous diameter, the second pin connected to another of the openings such that a second minor portion extends from the exterior side of the outer plate, wherein the second diameter is the same as the first diameter and the second minor portion extends from the outer plate a distance greater than the first minor portion;
a stud including a connection end having a cavity formed therein complementary to the second minor portion and an annulus formed about the cavity, wherein the stud is connected to the second pin such that the cavity is contiguous with a side surface and an end surface of the second minor portion and the annulus is contiguous with the outer plate.

2. The outer link of claim 1, wherein an interference fit connects the first pin and the second pin to the respective one and other openings.

3. The outer link of claim 1, wherein the distance is greater than 0.03 inches.

4. The outer link of claim 1, wherein the annulus is at least 0.04 inches.

5. The outer link of claim 1, wherein an interference fit connects the stud to the second pin.

6. The outer link of claim 1, wherein a weld joint connects the second pin to the other opening and the stud to the second pin and the outer plate.

7. The outer link of claim 1, wherein the stud includes a feature to facilitate connection of an attachment.

8. A method of manufacturing a roller chain comprising:
connecting a first pin, having a first continuous diameter, by interference fit to one opening defined in an outer plate such that a first minor portion extends from an exterior side of the outer plate;
connecting a second pin, having a second continuous diameter, by interference fit to another opening defined in the outer plate such that a second minor portion extends from the exterior side of the outer plate, wherein the second diameter is the same as the first diameter and the second minor portion extends from the outer plate a distance greater than the first minor portion;
connecting a stud, including a connection end having a cavity formed therein complementary to the second minor portion and an annulus formed about the cavity, by interference fit to the second minor portion such that the cavity is contiguous with a side surface and an end surface of the second minor portion and the annulus is contiguous with the outer plate; and
welding simultaneously the second pin to the other opening and the stud to the second pin and the outer plate.

9. The method of claim 8, further comprising inserting the first and second pins through respective bushings of an inner link.

10. The method of claim 8, further comprising connecting another outer plate to the first and second pins.

11. A roller chain comprising:
a series of alternating inner and outer links, wherein in at least one of the outer links includes an outer plate having a pair of equally configured openings defined therein;
a first pin having a first continuous diameter, the first pin connected to one of the openings such that a first minor portion extends from an exterior side of the outer plate;
a second pin having a second continuous diameter, the second pin connected to another of the openings such that a second minor portion extends from the exterior side of the outer plate, wherein the second diameter is the same as the first diameter and the second minor portion extends from the outer plate a distance greater than the first minor portion;
a stud including a connection end having a cavity formed therein complementary to the second minor portion and an annulus formed about the cavity, wherein the stud is connected to the second pin such that the cavity is contiguous with a side surface and an end surface of the second minor portion and the annulus is contiguous with the outer plate.

12. The outer link of claim 11, wherein an interference fit connects the first pin and the second pin to the respective one and other openings.

13. The outer link of claim 11, wherein the distance is greater than 0.03 inches.

14. The outer link of claim 11, wherein the annulus is at least 0.04 inches.

15. The outer link of claim 11, wherein an interference fit connects the stud to the second pin.

16. The outer link of claim 11, wherein a weld joint connects the second pin to the other opening and the stud to the second pin and the outer plate.

17. The outer link of claim 11, wherein the stud includes a feature to facilitate connection of an attachment.
